(19) United States
(12) Patent Application Publication
(10) Pub. No.: US 2013/0185095 A1
(43) Pub. Date: Jul. 18, 2013

(54) PAPERLESS PATIENT INFORMATION COLLECTION AND MANAGEMENT PROCESS AND SYSTEM

(71) Applicant: Samuel J. SHARPE, Kure Beach, NC (US)

(72) Inventor: Samuel J. SHARPE, Kure Beach, NC (US)

(21) Appl. No.: 13/544,409

(22) Filed: Jul. 9, 2012

Related U.S. Application Data
(60) Provisional application No. 61/505,297, filed on Jul. 7, 2011.

(51) Int. Cl. G06F 19/00

(52) U.S. Cl. CPC G06F 19/322
USPC 705/3

(57) ABSTRACT

A system for collecting and managing patient information includes a tablet device configured to provide information regarding a medical procedure to a patient. Tablet device is further configured to query a patient regarding important aspects of the medical procedure. The tablet device being further configured to receive input from the patient in response to the query. The system of further includes a server operating a database and configured to store the input from the patient in response to the query and a network configured to connect to the tablet device and the server.

### CROSS REFERENCE TO PRIOR APPLICATIONS

This application claims the benefit from U.S. Provisional Application No. 61/505,297 filed on Jul. 7, 2011, which is hereby incorporated by reference in its entirety for all purposes as if fully set forth herein.

### BACKGROUND OF THE DISCLOSURE

1. Field of Disclosure

This disclosure is directed to paperless medical form entry, and more particularly to a portable user device for collecting patient information.

2. Related Art

Patients who visit a doctor's office, a hospital, a testing facility and the like are frequently required to provide patient information, such as, e.g., personal information, medical information, insurance information and/or the like. Paper forms are typically used to provide such patient information. Paper forms are typically filled with many questions and medical terms while providing very little or no guidance on how to fill out the form or how to answer the questions. Especially, patients who do not speak English fluently find it difficult to complete the form without help from others. Further, the space for entering patient information is very often limited. Once a mistake is made, the patient may have to either obtain a new form and start over or correct the mistake by scratching the mistakenly entered information entirely, which may render the form messy and confusing to understand.

On the other hand, hospital personnel who review patient forms very often encounter various difficulties in reading and understanding the information in the paper form handwritten by patients. For example, when a patient completes a patient form for a magnetic resonance imaging (MRI) procedure, hospital personnel have to review the paper form to determine whether or not the MRI test could impose any health-related dangers to the potential MRI patient. However, it is very often difficult, confusing and time-consuming to understand hand-written patient information, which may lead to incorrect medical decisions or, in a worse case, medical malpractice. Further, it is not easy to access and share the hand-written information unless the information is manually entered into a database, which may be time-consuming and costly.

Of even greater importance is the fact that often times obtaining critical patient information prior to a procedure, such as a MRI procedure, can help determine whether or not a patient is eligible to participate in a particular procedure. Being able to obtain this information early and easily analyze it, prior to an appointment, will allow a physician to avoid making an appointment with a patient that is not eligible. This allows patients that do qualify for a procedure to be able to obtain an appointment earlier. It further allows physicians to more efficiently use their time and resources. In other words, such a system would avoid having a patient that is not qualified for a procedure make an appointment, only to subsequently find out this patient cannot have the procedure, and the unutilized appointment resulting in wasted time by the patient and by the physician.

Accordingly, there is a need for a better way to collect patient information from patients and manage the collected patient information.

### SUMMARY OF THE DISCLOSURE

According to an aspect of the disclosure, a system for collecting and managing patient information includes a tablet device configured to provide information regarding a medical procedure to a patient, configured to query a patient regarding important aspects of the medical procedure, and further configured to receive input from the patient in response to the query, a server operating a database and configured to store the input from the patient in response to the query, and a network configured to connect to the tablet device and the server.

The system may include at least one of the tablet device, the server, and the network may be configured to be HIPAA compliant. The tablet device may be an Apple iPad. The tablet device may be configured to audibly output the query to the patient. The tablet device may be configured to display the query to the patient. The tablet device may be configured to receive an input in response to the query to the patient by at least one of a keyboard input, selection button input, and radio button input. A health care provider with the proper authorization may view the information from any location having internet access. The tablet device may be configured to at least one of display and communicate a query to the patient in multiple languages.

According to an aspect of the disclosure, process for collecting and managing patient information includes providing information regarding a medical procedure to a patient utilizing a tablet device, querying a patient regarding important aspects of the medical procedure using the tablet device, receiving input from the patient in response to the query using the tablet device, storing the input from the patient in response to the query in a server operating a database, and connecting the tablet device and the server using a network.

The tablet device, the server, and the network may be configured to be HIPAA compliant. The tablet device may be an Apple iPad. The tablet device may be configured to audibly output the query to the patient. The tablet device may be configured to display the query to the patient. The tablet device may be configured to receive an input in response to the query to the patient by at least one of a keyboard input, selection button input, and radio button input. A health care provider with the proper authorization may view the information from any location having internet access. The tablet device may be configured to at least one of display and communicate a query to the patient in multiple languages.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a tablet device that may allow the patient to select a language operating in accordance with the invention;

FIG. 2 shows a tablet device displaying a warning statement to the patient operating in accordance with the invention;

FIG. 3 shows a tablet device that may allow questions to be read aloud operating in accordance with the invention;

FIG. 4 shows a tablet device which may display warnings and hazards operating in accordance with the invention;

FIG. 5 shows a tablet device which may allow the patient to enter personal information operating in accordance with the invention;

FIG. 6 shows a tablet device with an electronic on-screen keyboard a patient may use to enter the information in FIG. 5;

FIG. 7 shows a tablet device allowing the patient to answer questions operating in accordance with the invention;

FIG. 8 shows a tablet device allowing the patient to select certain medical conditions and devices that may prevent the patient from undergoing the contemplated medical procedure;

FIG. 9 shows a tablet device allowing the patient to enter any adverse prior experiences with the contemplated medical procedure;

FIG. 10 shows a tablet device allowing the patient to select whether the patient has experienced a side effect with a substance administered during the medical procedure;

FIG. 11 shows a tablet device allowing the patient to select whether the patient has or uses certain medical devices;

FIG. 12 shows a tablet device allowing the patient to select additional medical devices and displaying a warning that at least some medical devices may have to be removed prior to undergoing the contemplated medical procedure;

FIG. 13 shows a tablet device displaying the screen indicating that the patient has completed the medical form operating in accordance with the invention;

FIG. 14 shows a screen capture image of a web page for displaying a particular person's patient information collected via the tablet device and stored in a database, constructed according to the principles of the disclosure;

FIG. 15 shows a screen capture image of a web page for displaying additional patient information not shown in FIG. 14;

FIG. 16 shows a screen capture image of a web page for displaying a list of patients whose patient information has been collected and stored in a database, constructed according to the principles of the disclosure;

FIG. 17 shows an exemplary system configured in accordance with principles of the invention.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

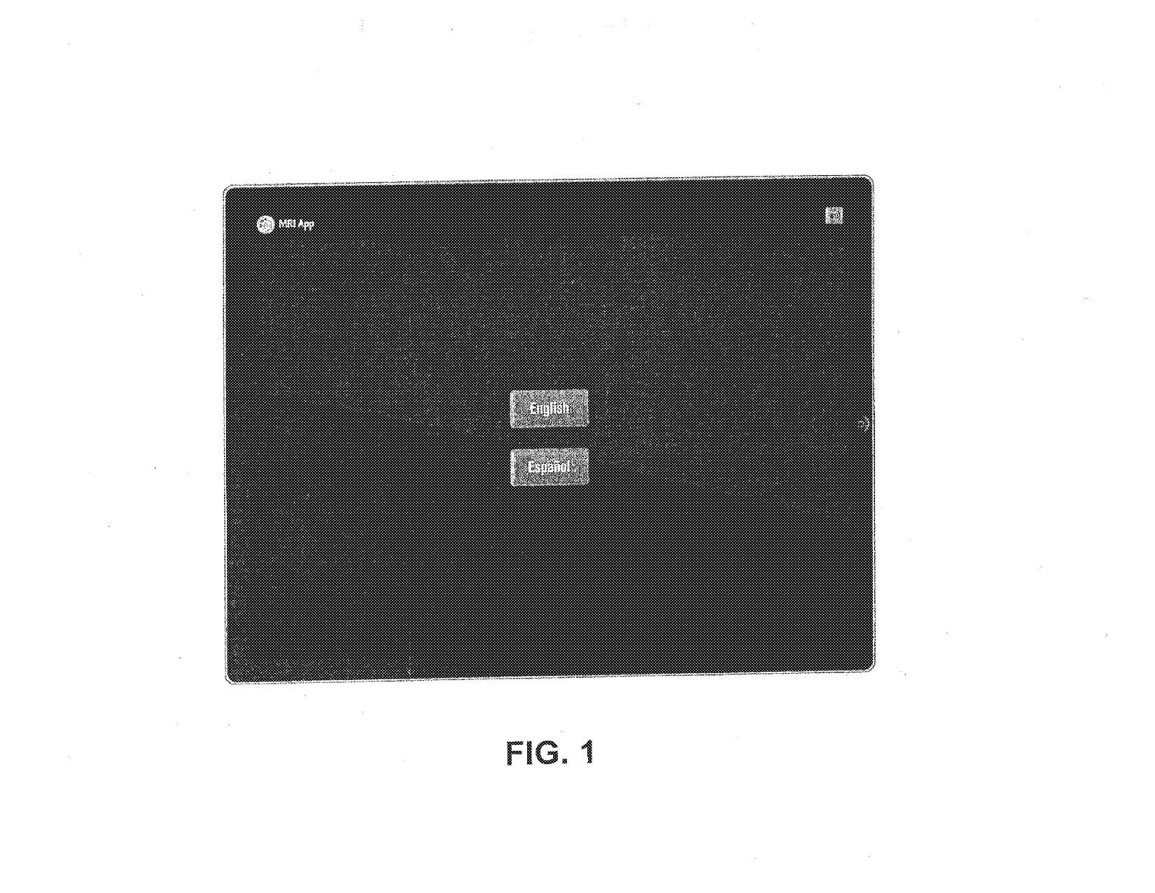

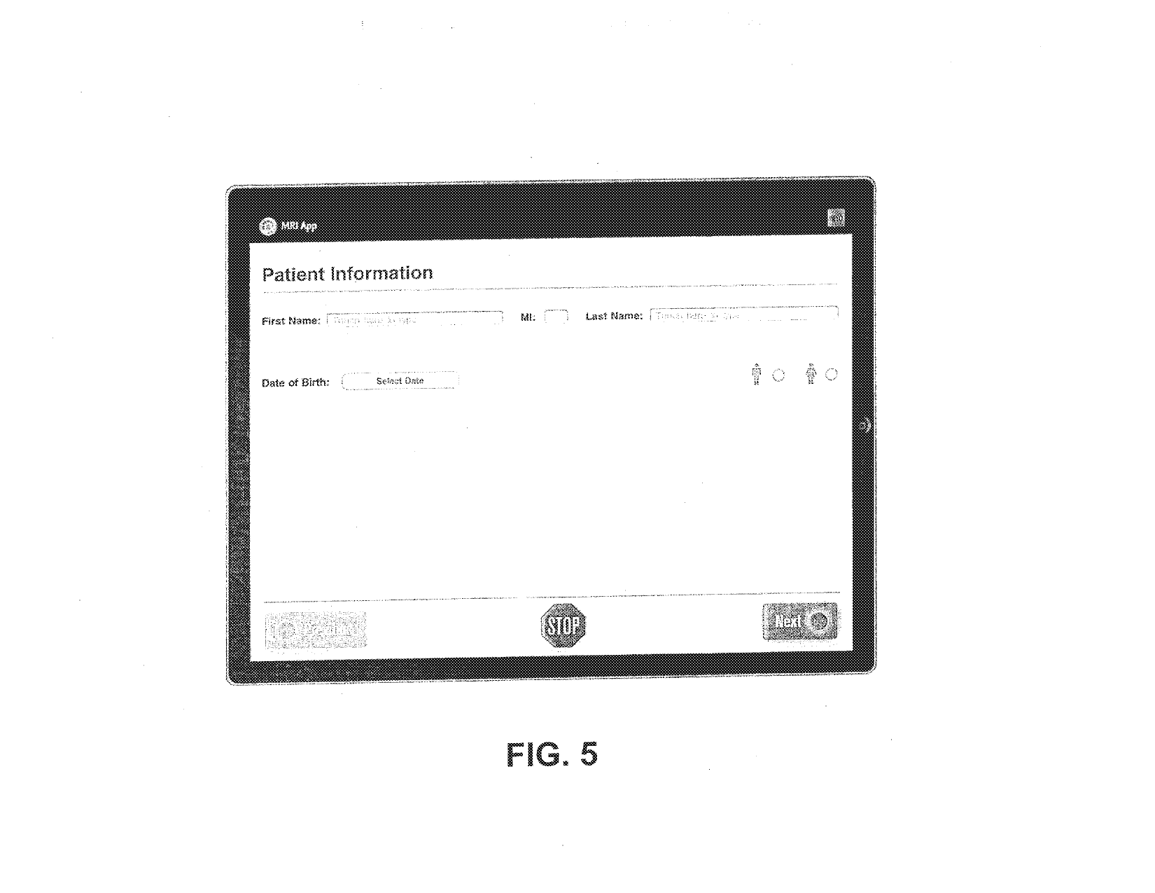

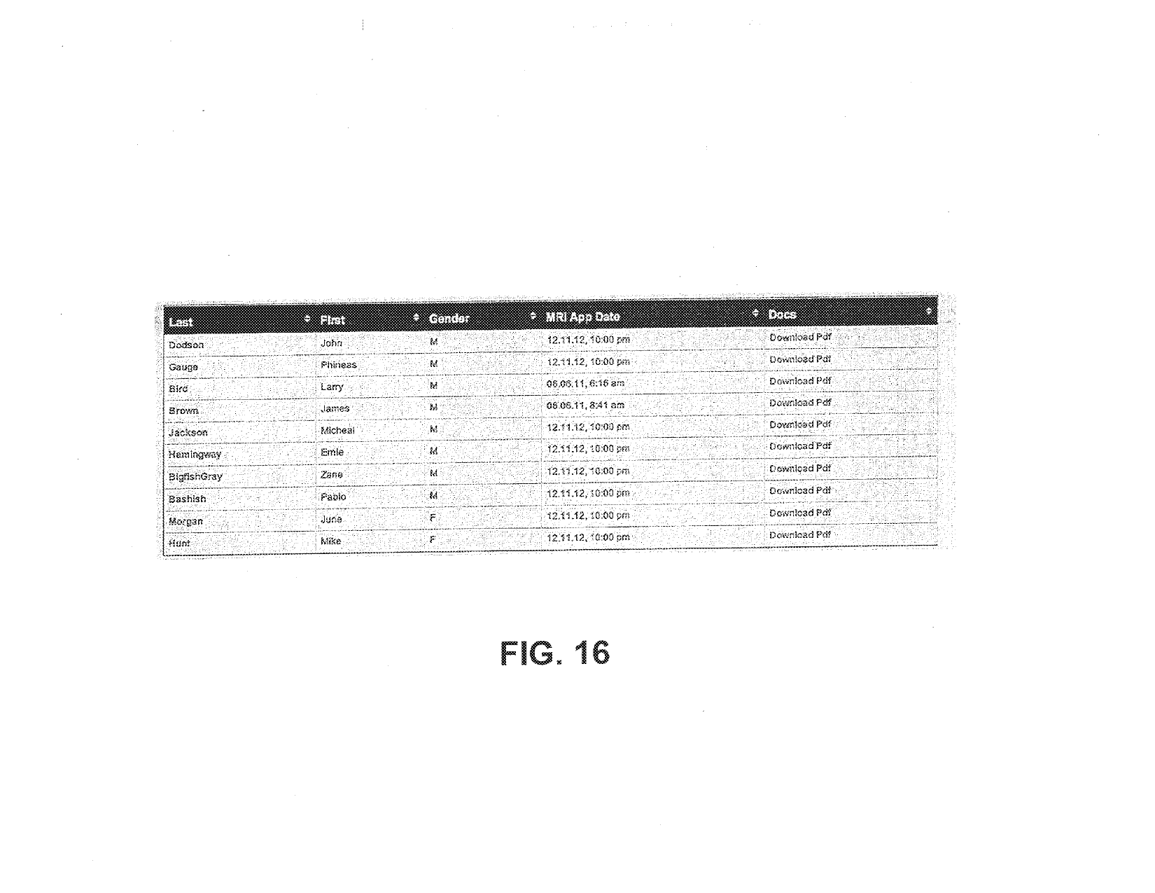

A system for collecting and managing patient information is disclosed. The system may include a tablet device, such as the one shown in FIGS. 1-13, a server, a data storage and/or the like, that may be connected to each other via one or more communication channels, such as, e.g., wired and wireless network and/or the like. The data storage may include a patient information database, such as the one shown in FIG. 16. The server may operate and manage the database stored in the data storage. As FIGS. 5-12 show, a patient and/or hospital personnel may use the tablet device to enter patient information. The tablet device may be configured with a user interface that is easy to read, understand, navigate, select answers and enter text. For example, the tablet device is an Apple iPad (provided by Apple Inc., Cupertino, Calif.) running an application for displaying various questions, notifications, warnings, disclaimers and/or the like. However, it should be noted that it is within the scope and spirit of the invention to use any type of Internet enabled device, tablet, or the like to collect patient information.

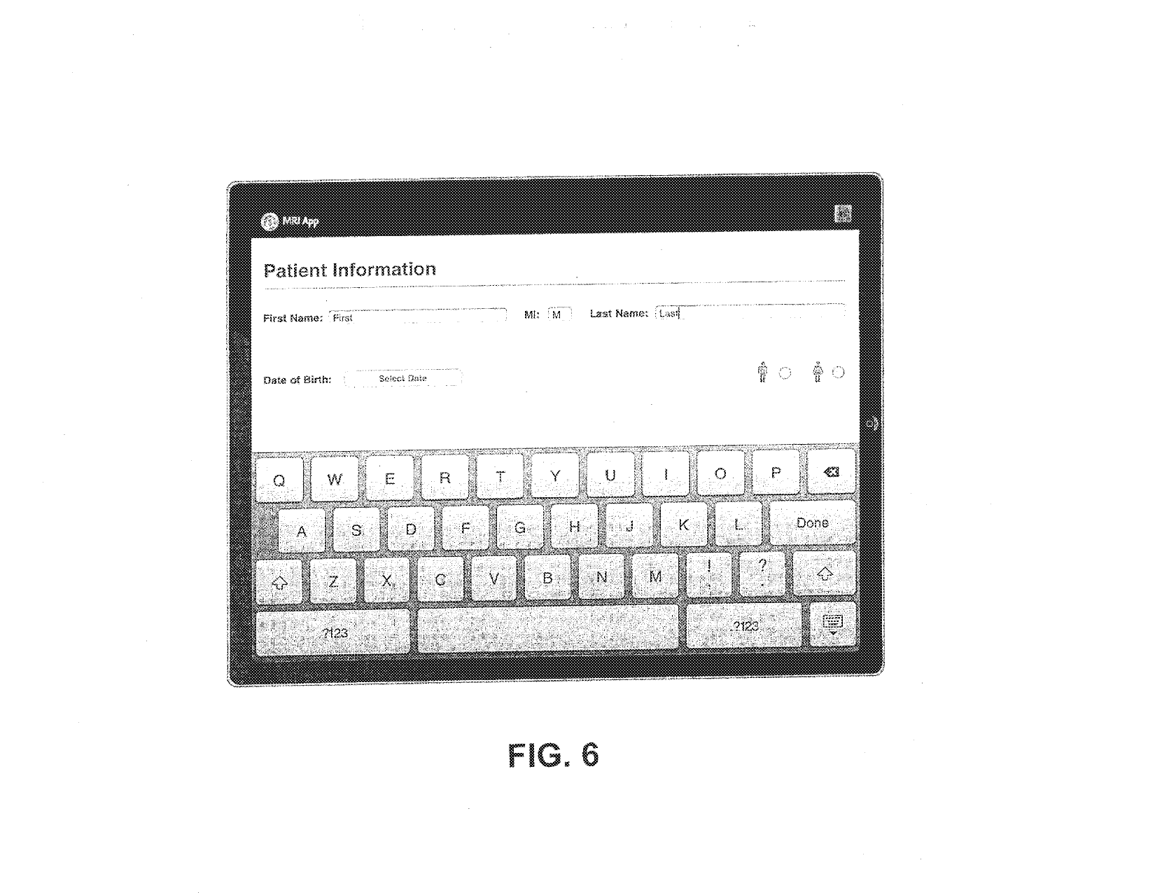

The patient may read the questions, notifications, warnings, disclaimers and/or the like and touch appropriate selection buttons displayed on the screens as shown in FIGS. 1-13. Further, the tablet device may display a keyboard on a screen, as shown in FIG. 6, to enter her or his patient information in the text format. The tablet device may send collected patient information to the server and the patient information may be stored in the database. The patient information stored in the database may be accessed anytime from anywhere.

For example, the tablet device may be used for MRI patient screening. The tablet device may be an interactive and secure patient screening device, which may allow patients to obtain direct attention from hospital personnel, such as, e.g., technologist assistant, MRI technologist, Radiologist or the like. By allowing the hospital personnel to access the MRI screening information first, issues that may complicate patient clearance for a MRI may be dealt with by those who are involved in performing the MRI procedure prior to the MRI being scheduled. This will avoid the cost of a canceled appointment due to a lack of eligibility.

The tablet device may run, for example, an MRI app, which may allow a potential MRI patient to read and/or listen to MRI screening questions and answer the questions by touching answer selection buttons (e.g., Yes, No and/or the like) displayed on the screen thereof.

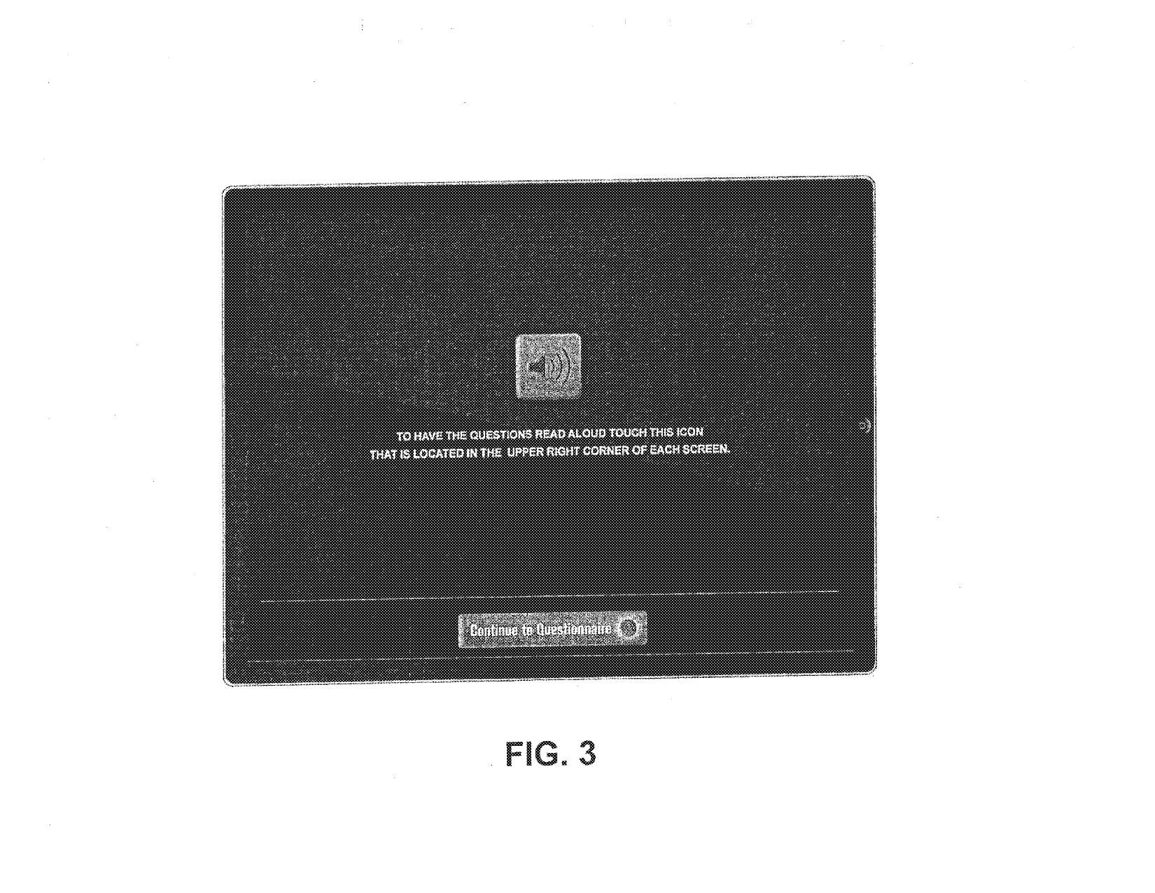

FIG. 3 shows a tablet device that may allow questions to be read aloud operating in accordance with the invention. As shown in FIG. 3, the MRI application may provide the patient with an option to listen to the questions in a desired language, such as, e.g., English, Spanish, French, German, Chinese, Japanese, Korean, and the like. The patient may type detailed information with a touch screen keyboard as shown in FIG. 6. Once submitted, the patient information from the tablet device may be sent over a secure network to the data storage and entered in a database. This information may be crucial to determine whether or not the patient is eligible to have, for example, an MRI procedure.

The information obtained by the data storage may be instantly available for review by anyone who has the right privileges to access the information. For example, the screening of potential MRI patients who do not speak English may be a major asset to the tablet device. The paper screening methods in practice today must use an interpreter to fill out answers to the questions, which brings about many complications, such as, e.g., time-consuming, ill-suited for the practice of good patient care and/or the like. The use of multiple language audio may address this issue and add efficiency over and above current approaches.

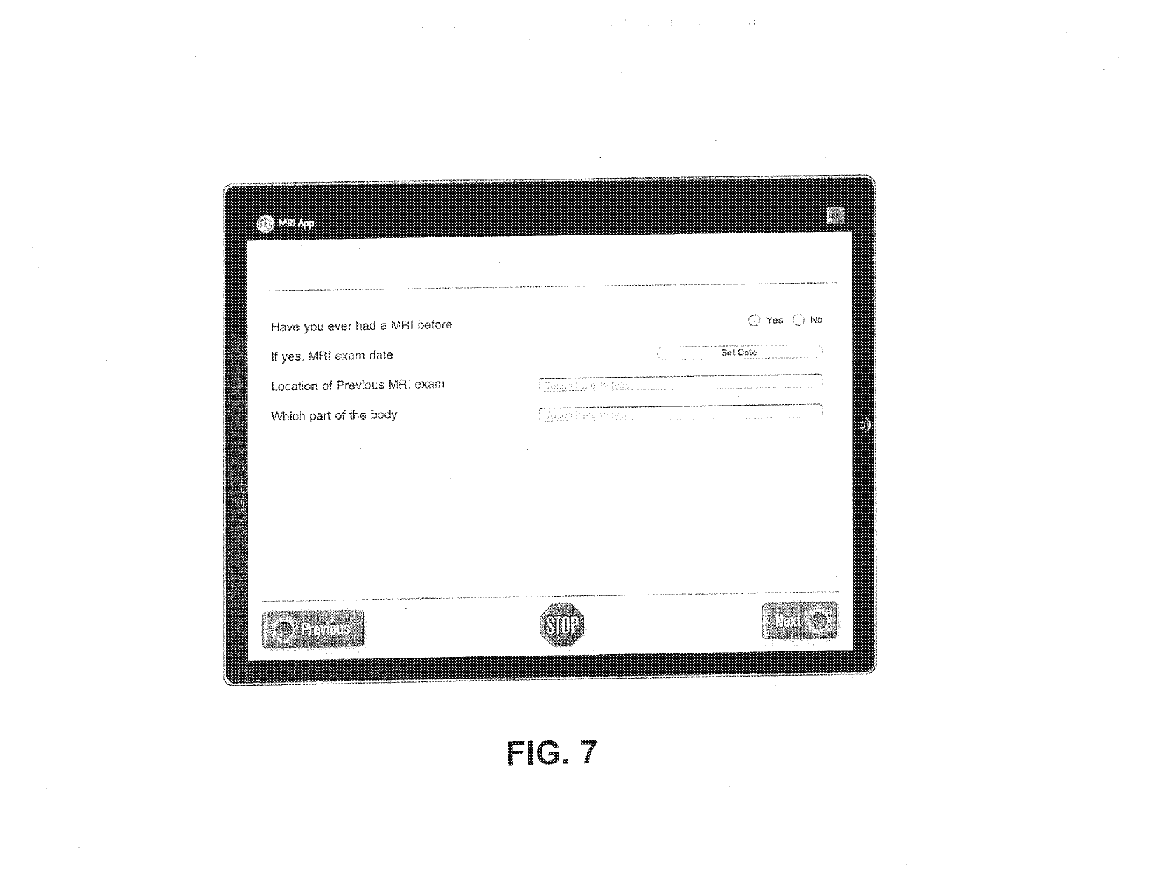

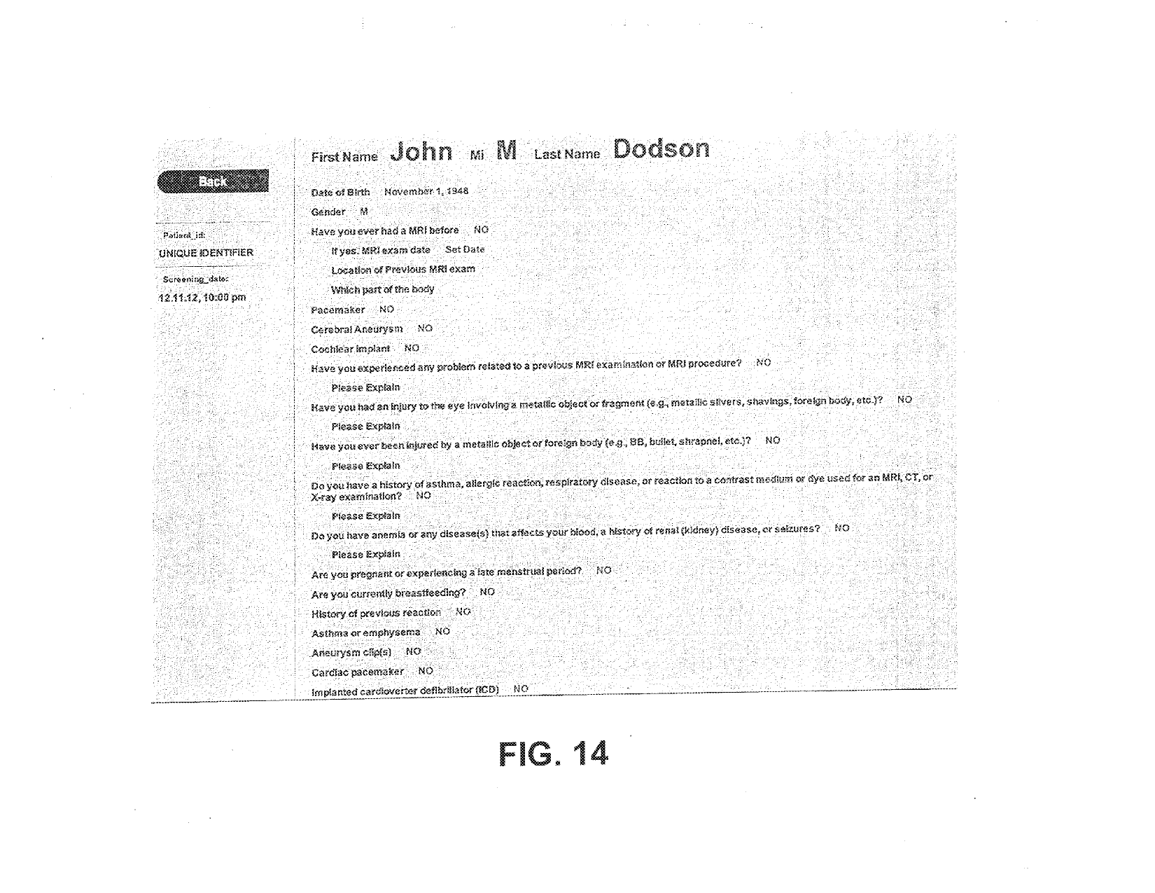

The paperless patient information collection and management system, including but not limited to an MRI app, may be an iPad application configured to allow a patient to fill out, for example, MRI screening information. The app's user interface may allow the patient to see and hear the screening questions and answer the questions by touching one of the selection buttons displayed thereon as shown in FIG. 7. Once completed, this information will be submitted over a secure wireless connection to the database. The server may then convert the submitted patient information into a PDF document or the like. The information may be accessed by visiting a secure and HIPAA-compliant website connected to the database, as shown in FIG. 14-16. Staff at, for example, an MRI imaging center may use a username and password to access this website to review the patient's information prior to or at the time of the patient's arrival for her or his MRI procedure preferably prior to scheduling an appointment to avoid the costs of canceling an appointment.

The website may be an interactive and secure web portal that allows the screening information generated from the paperless patient information collection and management system, such as an MRI app, to be viewed by the end user, such as, e.g., technologist assistant, MRI technologist, Radiologist and the like. If there are any questions or more information needed, the end user may conduct direct communication with the patient. The screening information generated by the application may be securely sent to the web portal and accessed by the MRI facility. Access to this information may be secured by a service provider who operates and manages the database and the website.

The paperless patient information collection and management system, such as an MRI app, may end impersonal treatment of patients, such as, e.g., handing out a clipboard of documents to fill it out. All of the information needed to properly screen and prepare a patient for an MRI exam may be streamlined with the MRI app. The audio function may allow patients to hear the questions read aloud. This may result in a more efficient and effective screening procedure. The documentation produced by the MRI application may be accessible by the end user instantly at the website. By providing essential information to the testing facilities quickly, patients may be scanned in a safe and timely manner, thereby reducing or eliminating unused scanner time. This approach may become even more useful with advance of electronic medical records.

The paperless patient information collection and management system, such as an MRI app, may also ask contrast questions, which may aid in determining if a patient needs a blood test saving time prior to the patient's arrival for scanning. Claustrophobia may be identified with an MRI app. This feature may decrease reschedules and unused exam time if the patient may need or request an open scanner for her or his procedure. This application may be customized to site specifications, exam times, and scanning procedures.

The paperless patient information collection and management system, such as an MRI app, may lower expenses by reducing or eliminating staff that are necessary in the current MRI screening procedures. Most facilities ask a potential patient the same screening questions several times during the scheduling process. By using an MRI app, the repetitive questioning of patients by administrative staff may be reduced or eliminated. A patient may be pre-cleared and walk into an MRI facility, sign consent paperwork along with the MRI application documentation, and proceed directly to the MRI scanner accompanied by an MRI technologist.

The use of a paperless patient information collection and management system, such as an MRI application and its web components, may reduce the amount of time it takes for a potential MRI patient to undergo an MRI procedure. The MRI application may allow an MRI facility to use the MRI application with infrastructure already in place. The use of information obtained by the MRI application in conjunction with the website may allow a potential MRI patient to receive direct attention from the end user of the information first. This may reduce or eliminate frequent redundant calls back and forth between offices, which is currently one the main reasons for slowing down the MRI procedure.

The inherent risk associated with, for example, an MRI procedure may be minimized by allowing the end user to follow up on potential hazards quickly, prior to each patient's scheduling and/or arrival for her or his procedure. By allowing a potential MRI patient to answer MRI screening questions prior to her or his arrival for an MRI procedure, the screening and clearance of the patient may be completed before the patient's arrival for an MRI exam. Instant access to crucial patient information by the facility performing a procedure may be imperative for better patient care. With access to the website, an MRI facility may have the ability to streamline the patient flow process currently in practice. This approach may directly increase scanner efficiency by removing patients that would normally have to be cancelled or rescheduled due to screening contraindications prior to arrival and in some instances prior to even being placed on the schedule. By reducing or eliminating reschedules and cancellations, a facility may see a boost in revenue by increasing scanner-on time. The system disclosed above may be used for medical and non-medical purposes.

FIG. 1 shows a tablet device that may allow the patient to select a language operating in accordance with the invention. In particular, FIG. 1 shows the ability for the patient to select a particular language. In this regard, the patient can use the touchscreen capability of the application and the tablet device to select buttons as shown in FIG. 1 to set the subsequent language of the application for the remaining part of the patient's use of the application. Although only two choices are shown in FIG. 1, it is within the spirit and scope of the invention to allow for many different languages.

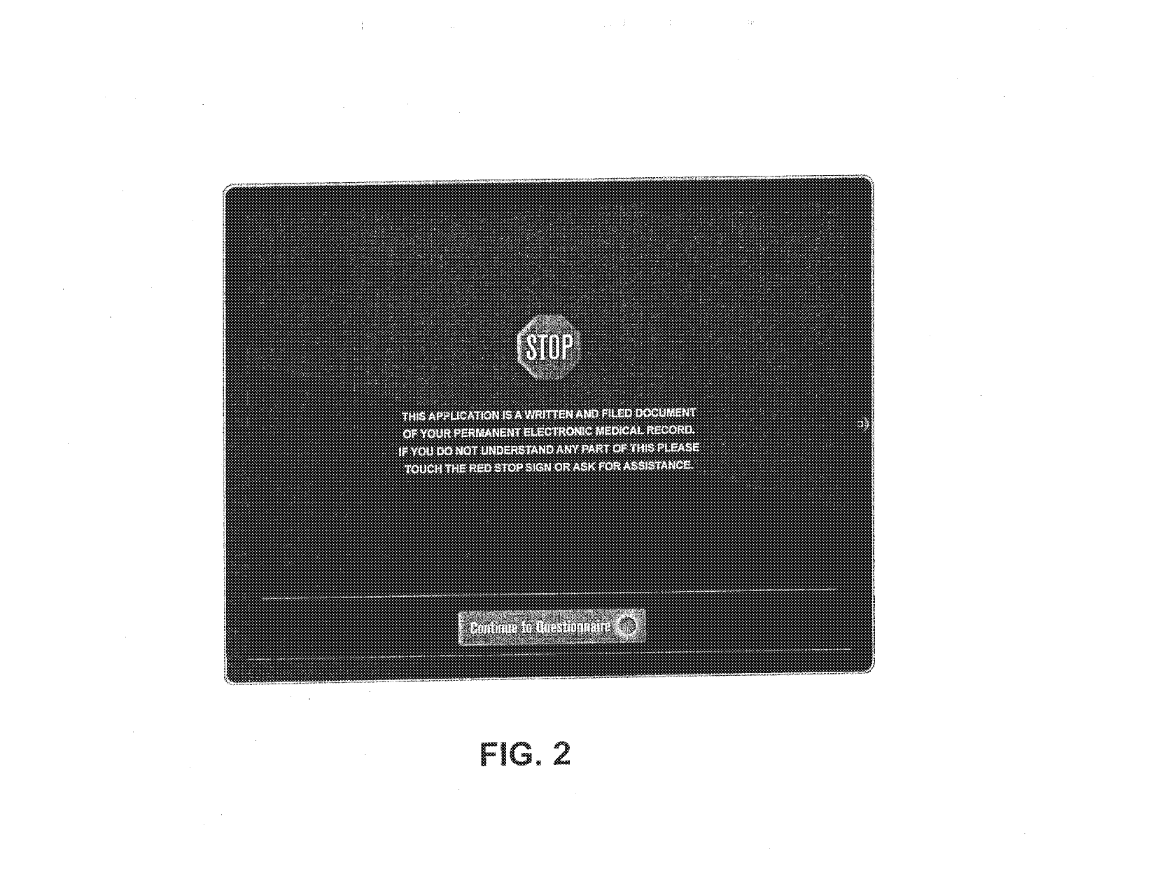

FIG. 2 shows a tablet device displaying a warning statement to the patient operating in accordance with the invention. As shown in FIG. 2, a warning may be provided to the patient so that the patient will be aware that information is critical. Of course, any type of warning or no warning may be included in the application.

FIG. 3 shows a tablet device that may allow questions to be read aloud operating in accordance with the invention. The screen in FIG. 3 allows the patient to select an audio output for the reading of questions that are associated with the application. As noted above, this may have many benefits for a patient who has poor eyesight and/or a limited ability to read. The questions may be prerecorded MP3 type files which are played by the tablet computer in order of the desired query process.

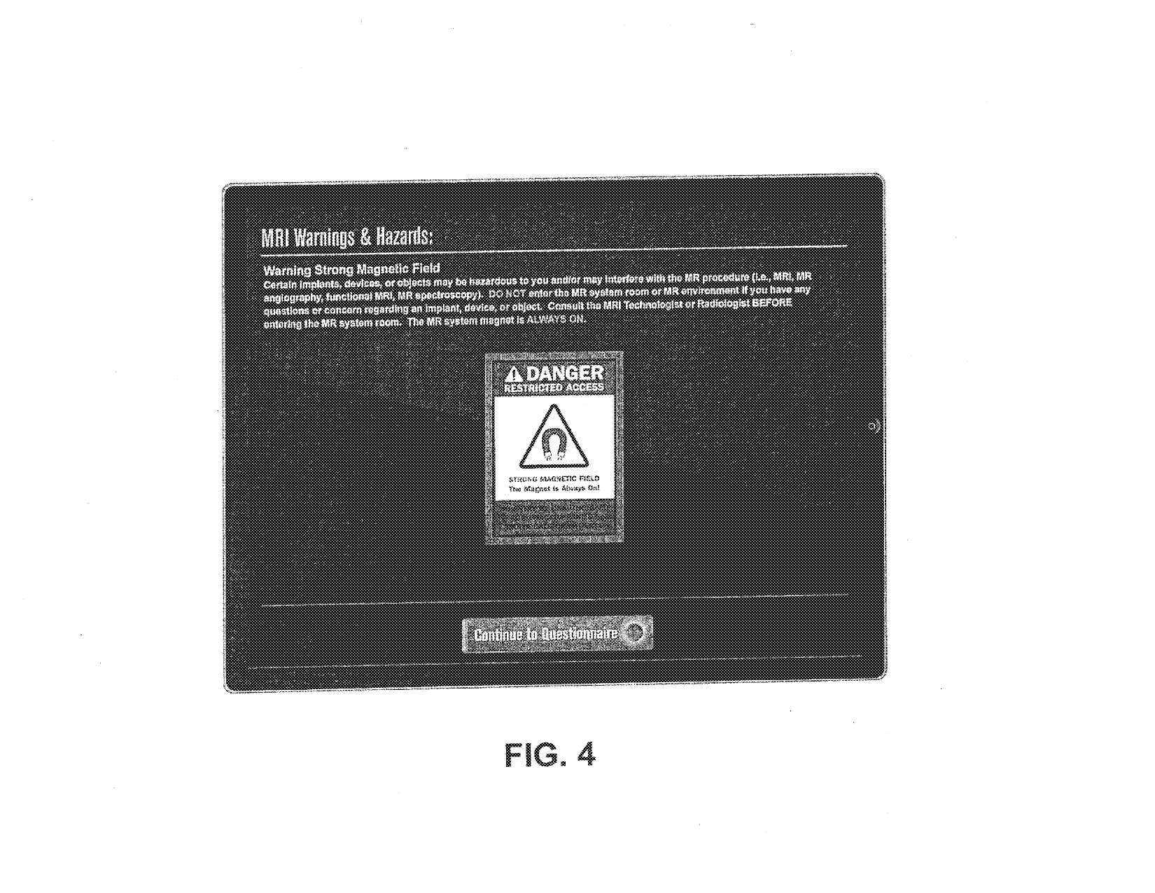

FIG. 4 shows a tablet device which may display warnings and hazards operating in accordance with the invention. As shown in FIG. 4, the patient may be provided with various warnings and hazards associated with a particular medical procedure. The language of this warning or hazard is exemplary. Any language may be utilized in this warning. The selection of the continue button may be indicative of the patient having read this particular screen.

FIG. 5 shows a tablet device which may allow the patient to enter personal information operating in accordance with the invention. The information requested in the screen is exemplary, any type of patient information may be entered in this particular screen, such as shown in FIG. 5, or multiple screens. The information entered in FIG. 5 may then be stored in the tablet or other database.

FIG. 6 shows a tablet device with an electronic on-screen keyboard that a patient may use to enter the information in FIG. 5. In particular, FIG. 6 shows exemplary input capability in the form of a touch sensitive screen having a QWERTY type keyboard. Other types of input configurations, including speech recognition and/or a separate input device such as a keyboard, are contemplated as well.

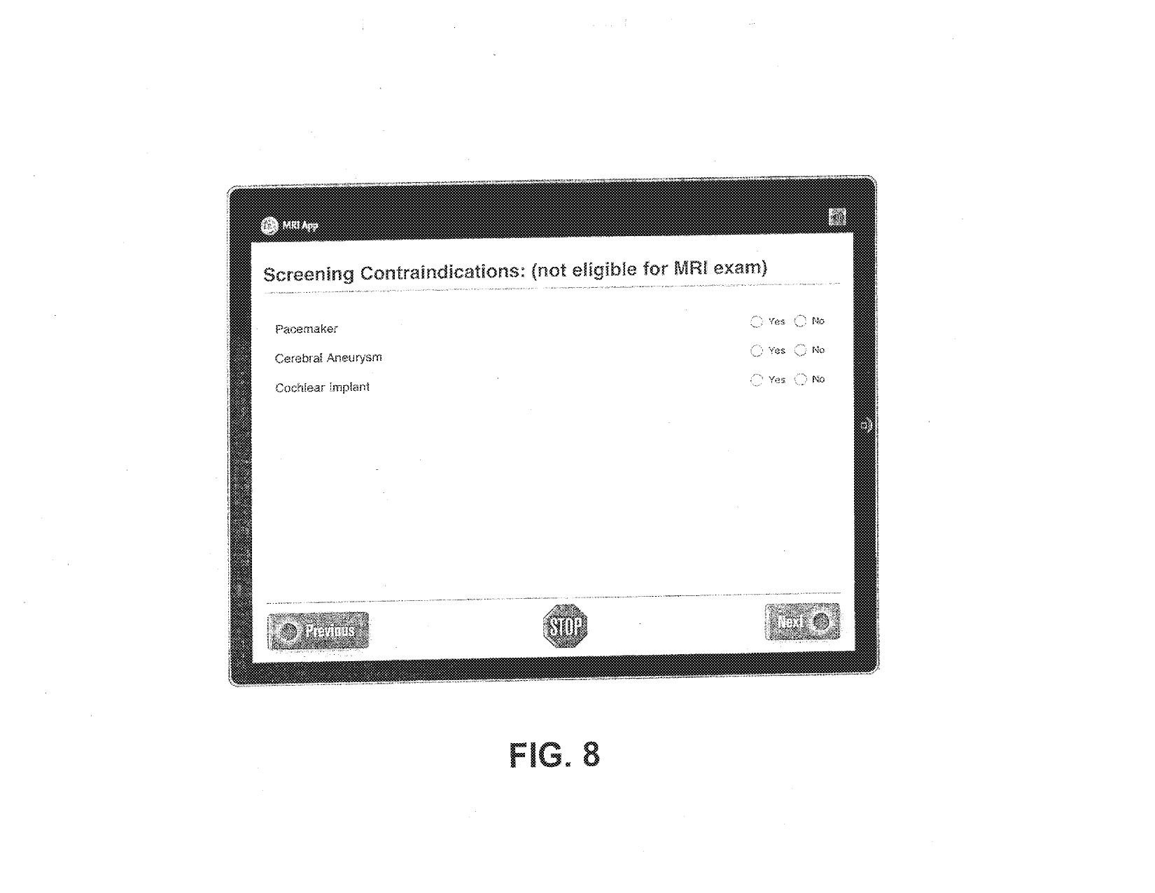

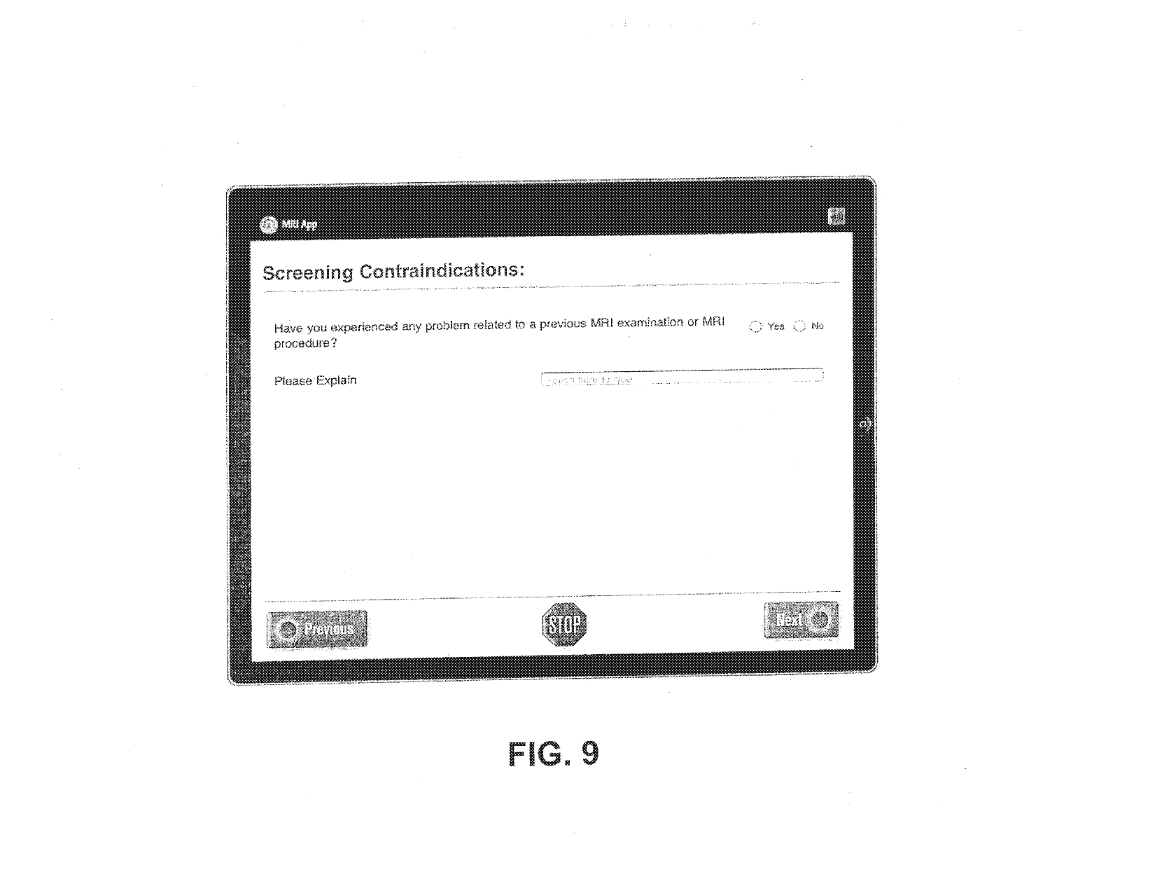

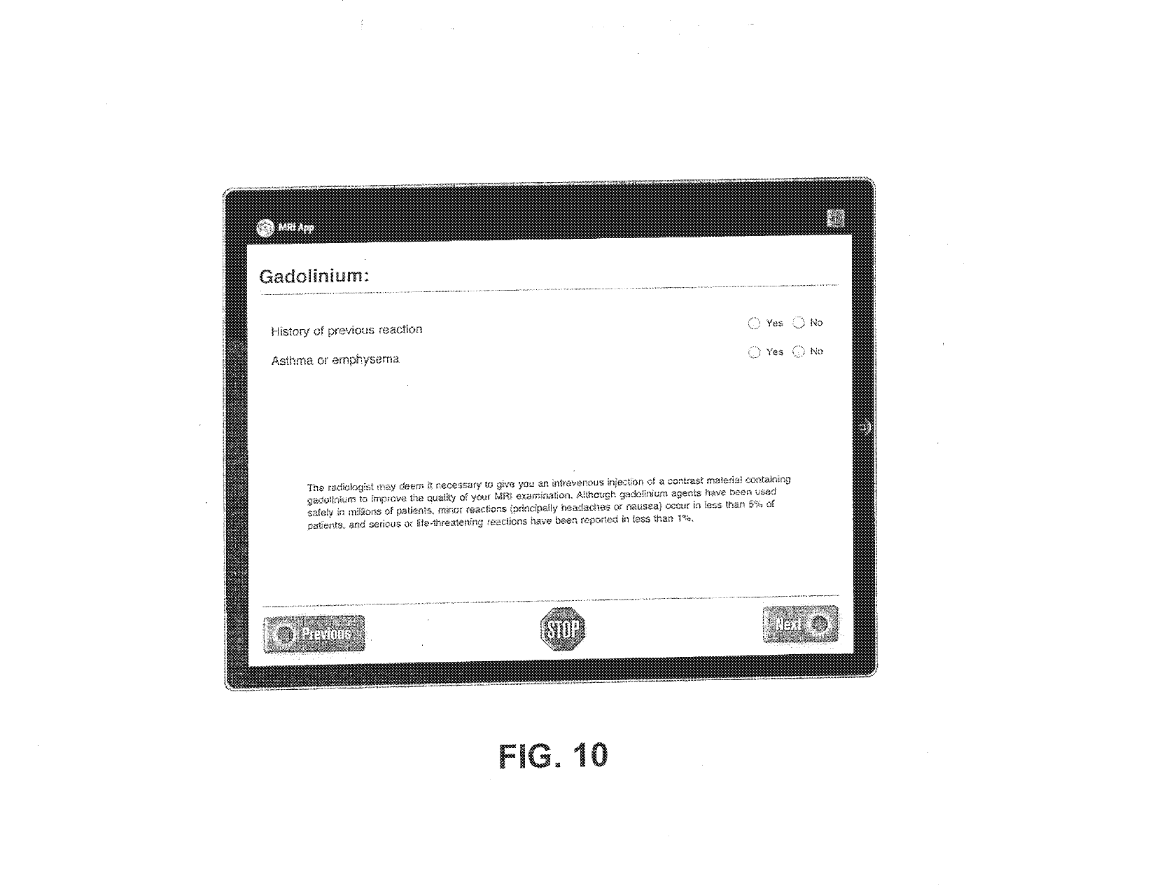

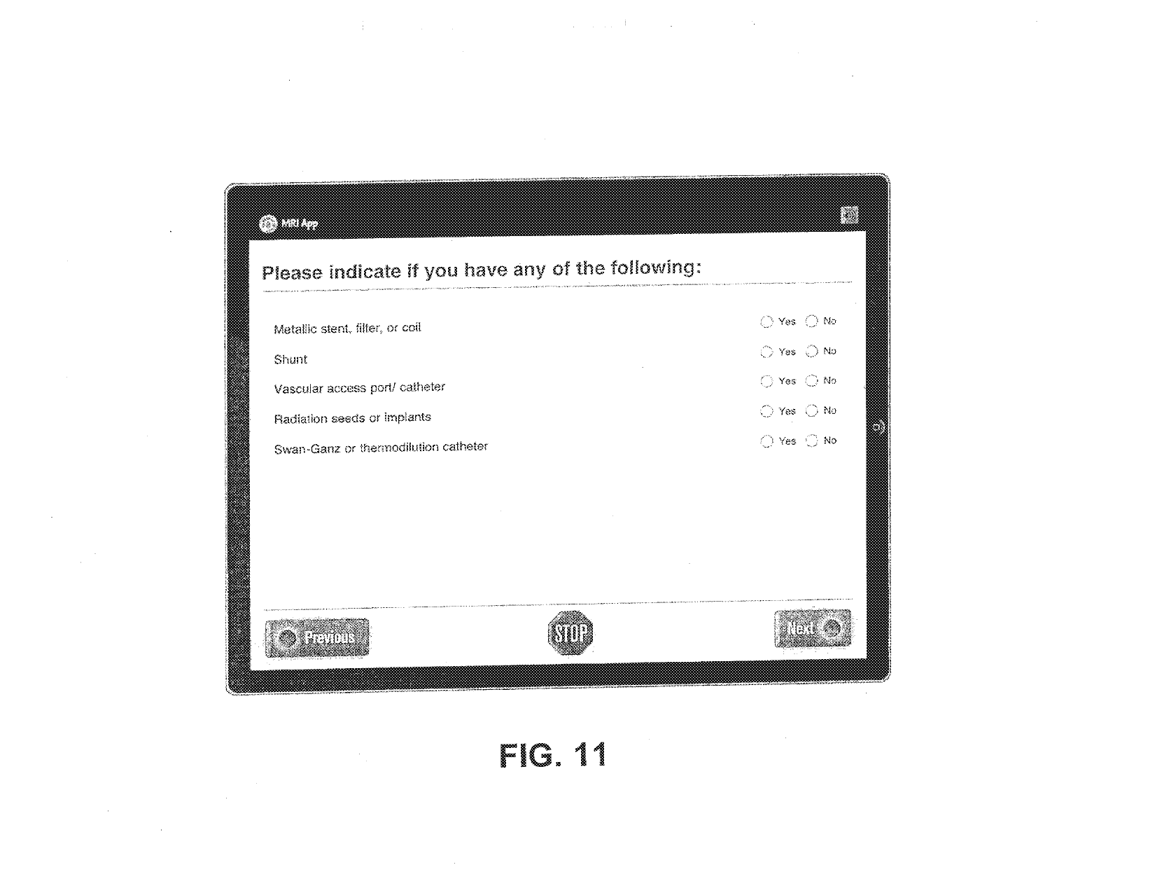

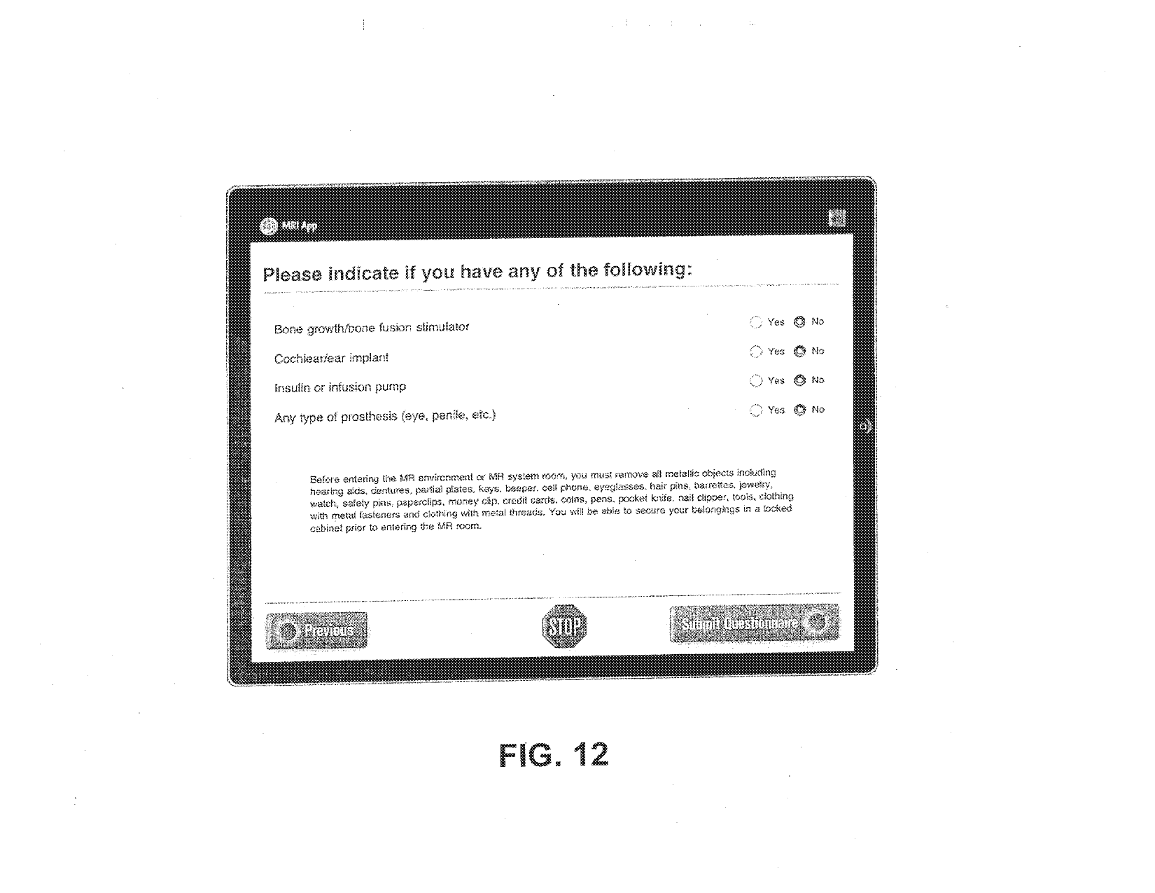

FIG. 7 shows a tablet device allowing the patient to answer questions operating in accordance with the invention; FIG. 8 shows a tablet device allowing the patient to select certain medical conditions and devices that may prevent the patient from undergoing the contemplated medical procedure; FIG. 9 shows a tablet device allowing the patient to enter any adverse prior experiences with the contemplated medical procedure; FIG. 10 shows a tablet device allowing the patient to select whether the patient has experienced a side effect with a substance administered during the medical procedure; FIG. 11 shows a tablet device allowing the patient to select whether the patient has or uses certain medical devices; and FIG. 12 shows a tablet device allowing the patient to select additional medical devices and displaying a warning that at least some medical devices may have to be removed prior to undergoing the contemplated medical procedure. Each of FIGS. 7, 8, 9, 10, 11, and 12 show various exemplary questions associated with the procedure that is contemplated by the patient. Other screens, questions, and procedures are of course contemplated by the invention herein.

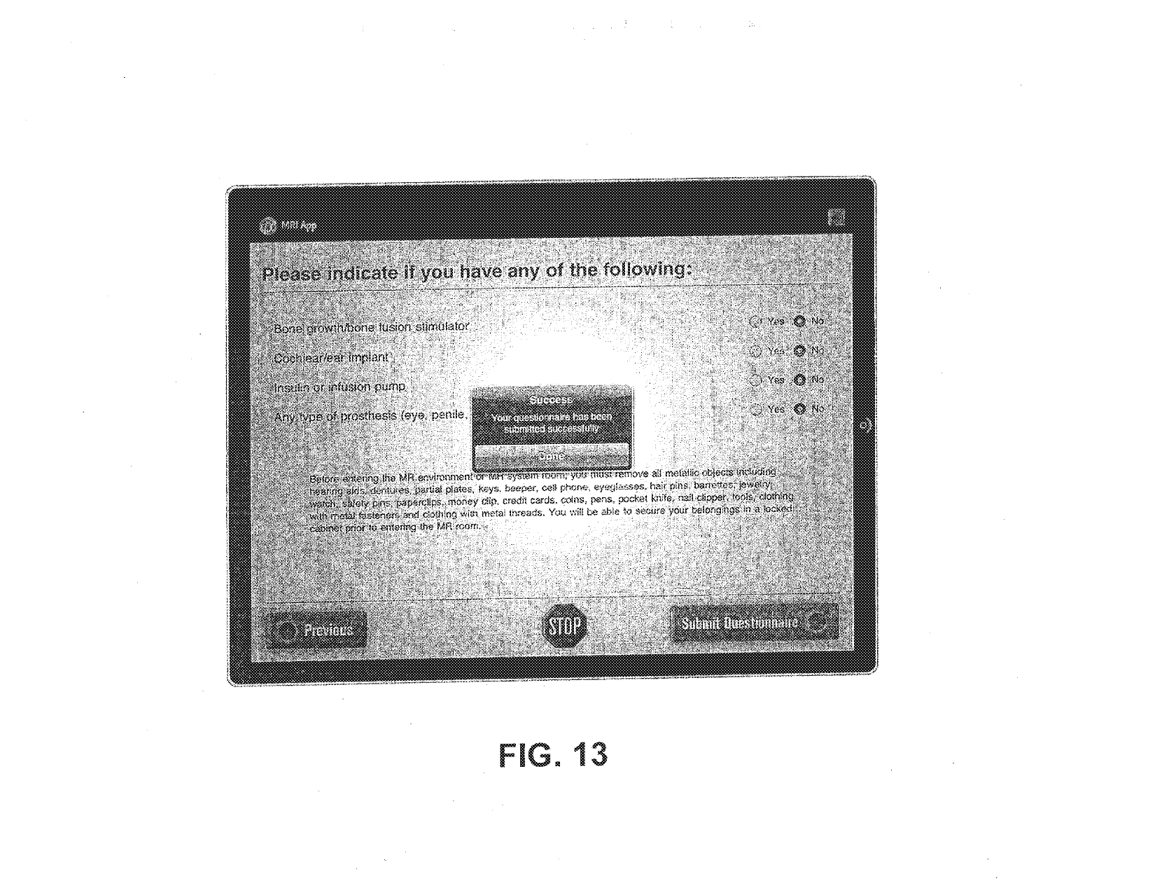

FIG. 13 shows a tablet device displaying the screen indicating that the patient has completed the medical form operating in accordance with the invention. In particular, FIG. 13 provides the patient with feedback when the application has received all the information needed for the procedure.

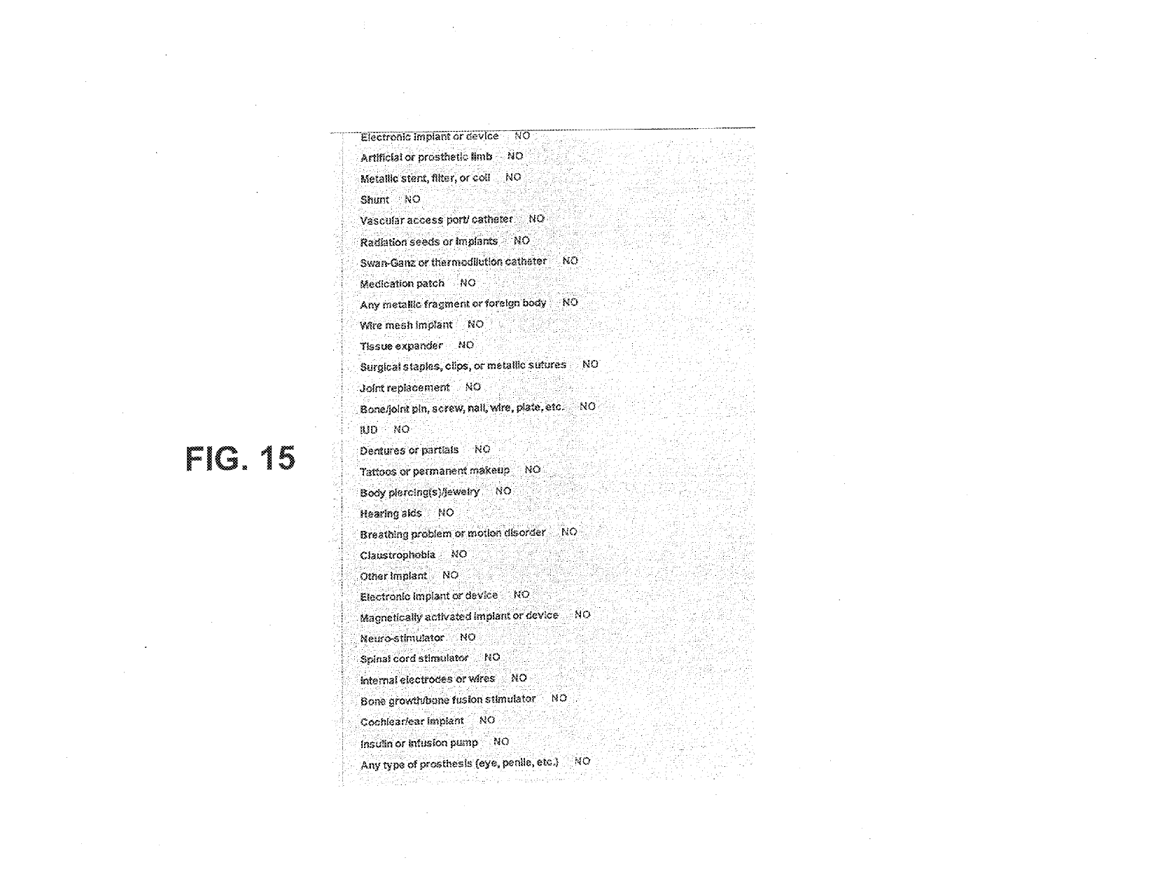

FIG. 14 shows a screen capture image of a web page for displaying a particular person's patient information collected via the tablet device and stored in a database, constructed according to the principles of the disclosure; FIG. 15 shows a screen capture image of a web page for displaying additional patient information not shown in FIG. 14; and FIG. 16 shows a screen capture image of a web page for displaying a list of patients whose patient information has been collected and stored in a database, constructed according to the principles of the disclosure. In particular, FIGS. 14, 15, and 16 show various ways in which the information captured by the application may be displayed for use by a physician or a physician's office employee for review and determination of eligibility for a particular procedure.

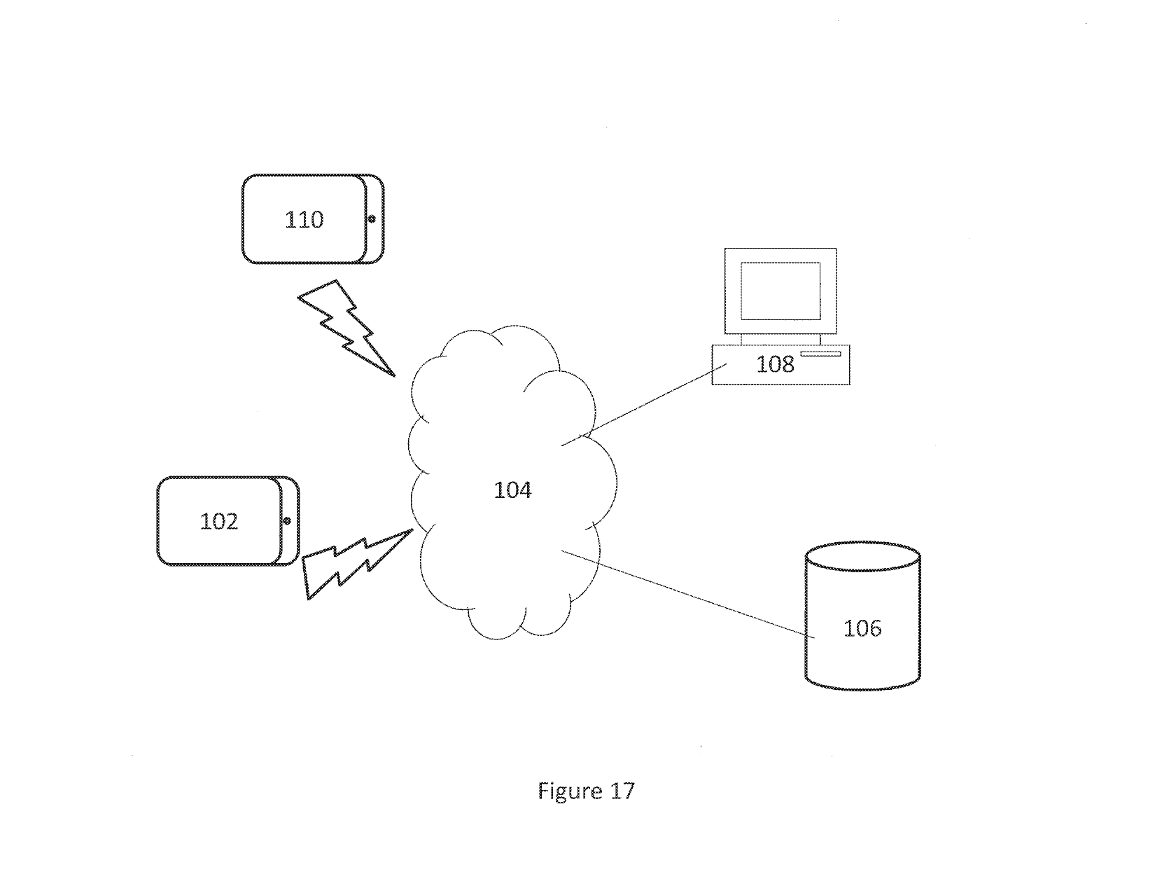

FIG. 17 shows an exemplary system configured in accordance with principles of the invention. In particular, FIG. 17 shows a tablet computer 102 that may be utilized in the practice of the invention. The tablet computer 102 may provide one or more of the capabilities noted above to allow a patient and/or a physician's office employee to enter medical information into the application operating on the tablet 102.

The tablet computer 102 may include a display. The display may be an LCD touch sensitive display having a backlit configuration. The tablet computer 102 may further include a processor for processing instructions and for executing the application associated with the invention. The tablet computer 102 may further include a memory for storing the application associated with the invention. The memory may be a random access memory or the like. The memory may further include the ability to execute other instructions associated with the tablet computer 102. Additionally the memory may include audio files, such as MP3 files, associated with the audio of queries described above. The tablet computer 102 may further include an audio output device including a speaker and a digital to analog converter. The speaker and digital to analog converter together with the processor may be configured to provide the speech output associated with the invention as described above. The tablet computer 102 may further include other types of output capability and further include other types of input capability. Tablet computer 102 may further include a wireless transceiver such as wireless fidelity (Wi-Fi utilizing a wireless protocol such as IEEE 802.11n) for transmission or reception of data as described above. Finally, the tablet computer 102 may include a battery so that tablet computer 102 may not be constrained by the need to provide wired power.

The tablet computer 102 may connect to a network 104. The data connection between the tablet computer 102 and the network 104 may be wired, wireless, or the like. In particular, the data connection may be a secure and HIPAA compliant data connection. For example, the data connection may be a secure socket layer (SSL) type of connection. More specifically, the tablet 102 may send the patient information collected by the application to the network 104. The network 104 may connect to a database 106. Again the connection between the network 104 and database 106 may be wired, wireless, or the like. Additionally the database and the connection and may be HIPAA compliant.

The database 106 may store the patient information as described in detail above. When the patient information is needed, the information again may be transmitted across network 104 to a physician, physician's office employee, or the like utilizing a tablet 110 and/or the computer 108.

Accordingly, the application utilizing the tablet computer of the invention provides a beneficial way for a patient to receive information and provide information to a physician or physician's office regarding a particular procedure. Although the use of the invention with a MRI procedure is described and is well-suited for the invention, any type of medical procedure is contemplated for use with the invention.

In an embodiment, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various embodiments of the invention, the system and methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the system and methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

In an embodiment, the invention may be web-based. For example, a server may operate a web application to allow the invention to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A system for collecting and managing patient information comprising:
a tablet device configured to provide information regarding a medical procedure to a patient, configured to query a patient regarding important aspects of the medical procedure, and further configured to receive input from the patient in response to the query;
a server operating a database and configured to store the input from the patient in response to the query; and
a network configured to connect to the tablet device and the server.

2. The system of claim 1, wherein at least one of the tablet device, the server, and the network are configured to be HIPAA compliant.

3. The system of claim 1, wherein the tablet device is an Apple iPad.

4. The system of claim 1, wherein the tablet device is configured to audibly output the query to the patient.

5. The system of claim 1, wherein the tablet device is configured to display the query to the patient.

6. The system of claim 1, wherein the tablet device is configured to receive an input in response to the query to the patient by at least one of a keyboard input, selection button input, and radio button input.

7. The system of claim 1, wherein a health care provider with the proper authorization can view the information from any location having internet access.

8. The system of claim 1, wherein the tablet device is configured to at least one of display and communicate a query to the patient in multiple languages.

9. A process for collecting and managing patient information comprising the steps of:
providing information regarding a medical procedure to a patient utilizing a tablet device;
querying a patient regarding important aspects of the medical procedure using the tablet device;
receiving input from the patient in response to the query using the tablet device;
storing the input from the patient in response to the query in a server operating a database; and
connecting the tablet device and the server using a network.

10. The process of claim 9, wherein at least one of the tablet device, the server, and the network are configured to be HIPAA compliant.

11. The process of claim 9, wherein the tablet device is an Apple iPad.

12. The process of claim 9, wherein the tablet device is configured to audibly output the query to the patient.

13. The process of claim 9, wherein the tablet device is configured to display the query to the patient.

14. The process of claim 9, wherein the tablet device is configured to receive an input in response to the query to the patient by at least one of a keyboard input, selection button input, and radio button input.

15. The process of claim 9, wherein a health care provider with the proper authorization can view the information from any location having internet access.

16. The process of claim 9, wherein the tablet device is configured to at least one of display and communicate a query to the patient in multiple languages.
